(19) United States
(12) Patent Application Publication
(10) Pub. No.: US 2014/0272828 A1
(43) Pub. Date: Sep. 18, 2014

(54) COMPONENTS FOR STEM EDUCATION

(71) Applicant: Blue Egg Advisory Group LLC, New York, NY (US)

(72) Inventors: David R. SUTTON, New York, NY (US); Robert McCALLUM, New York, NY (US)

(73) Assignee: Blue Egg Advisory Group LLC, New York, NY (US)

(21) Appl. No.: 14/209,447

(22) Filed: Mar. 13, 2014

Related U.S. Application Data
(63) Continuation-in-part of application No. 29/449,698, filed on Mar. 15, 2013.
Application No. 29/449,698 is a continuation-in-part of application No. 29/449,702, filed on Mar. 15, 2013.
(60) Provisional application No. 61/790,855, filed on Mar. 15, 2013.

(51) Int. Cl. G09B 19/00; G09B 23/02; G09B 23/00

(52) U.S. Cl. CPC G09B 19/0069; G09B 23/00; G09B 23/02
USPC 434/188; 434/276

(57) ABSTRACT

Provided herein are construction kits and methods of using the construction kits. The construction kit comprises one or more connector elements and one or more elongate members. Each connector element has a substantially regular prismatic shape and each face of each connector element has a substantially centrally-located opening located thereon to receive an end of an elongate member therein or therethrough. To assist with learning, each connector and rod of the kit can be assigned variable values depending on the educational level of a user. For example, a lower grade may have a coloured elongate member with an integer value, whereas that same coloured elongate member may have a fractional value for a higher grade.

### CROSS REFERENCE TO RELATED APPLICATIONS

This application claims the benefit of U.S. Provisional Application No. 61/790,855, filed Mar. 15, 2013, and is a continuation-in-part of U.S. Design Application Nos. 29/449,698 and 29/449,702, filed Mar. 15, 2013, each of which is hereby incorporated by reference in its entirety.

### FIELD OF THE INVENTION

The present invention relates to connectors and elongate members that link the connectors. These components may be used in an educational setting to support student learning, particularly in STEM or STEAM learning.

### BACKGROUND TO THE INVENTION

STEM is an acronym for Science, Technology, Engineering and Mathematics and STEM education is the teaching of such subject areas, while STEAM education links Science and Technology with Art as a subject area as well. During a child's early years of development, she/he is most open to experiential learning activities. It is believed that if children are able to experience hands-on, experiential learning activities early in their educational process, this will create interest and excitement and will greatly facilitate students' understanding and appreciation of STEM subjects. Unfortunately, in the early years of their schooling, students are less likely to be exposed to STEM education in the same way that they are exposed to the humanities.

One of the reasons for this is that the teachers who are trained to teach in the younger years are most often themselves not scientifically or mathematically trained and generally tend to shy away from teaching these subject areas tending instead to focus on those areas in which they generally feel most comfortable, such as the arts and the humanities. It is imperative that teachers of early learners are encouraged to teach STEM subjects.

Alternatively, there is also a need to extend the learning of those students who have real aptitude in STEM subjects, and to pose real challenges which promote unconventional, innovative thinking in such students.

Many governments in developed countries have expressed their concern about the declining state of STEM education. Accordingly, there is a push to expand and support the teaching of STEM-related subjects. The goals of such a push are: (i) to strengthen the skills of teachers through additional training in STEM; (ii) to increase that country's talent pools of scientists, engineers and mathematicians by improving K-12 Science and Mathematics education; (iii) to enlarge the pipeline of students prepared to enter college and graduate with STEM degrees; and (iv) to encourage innovation.

Teachers will realise that since the STEM subjects are very closely related, it would be desirable for resources for one subject area to be readily adaptable for use in other areas. Further, to enable linkage between STEM and the arts, where the latter is a learning area that in the past has generally been more readily facilitated, it may be possible to encourage learning in the STEM subjects through the arts and vice-versa. The present invention seeks to provide such an educational resource.

### SUMMARY OF THE INVENTION

According to one aspect of the present invention there may be provided a construction kit comprising: at least one connector element/s; and at least one elongate member/s; wherein each connector element has a substantially regular prismatic shape and wherein each face of each connector element has a substantially centrally-located opening located thereon to receive an end of an elongate member therein or therethrough. Preferably, the construction kit comprises elongate members of differing lengths and optionally, colours, wherein each colour is uniquely assigned to a given length of elongate member.

In particular embodiments of the present invention, the shapes of the connector elements are selected from the group consisting of: cuboids, pentagonal prisms, hexagonal prisms, and octagonal prisms, wherein each connector element has two end faces and at least four side faces. Preferably, the opening on each face is correspondingly adapted to receive an end of an elongate member therein or therethrough. More preferably, the opening on each side face is further adapted to frictionally and releasably retain the end the elongate member.

### BRIEF DESCRIPTION OF THE DRAWINGS

FIG. 1 shows an exemplary hexagonal, prismatic connector element according to an embodiment of the present invention. Views shown are (A) an isometric view; (B) a plan view from an end; and (C) a side view.

FIG. 2 shows views of the connector element of FIG. 1 when engaged with an elongate member via a side face. Views shown are: (A) a plan view from an end; (B) a cross-sectional side view through A-A; and (C) an isometric view.

FIG. 3 shows a cross-sectional side view through a two-piece connector element according to FIG. 1.

FIG. 4 shows exemplary triangles (A, B) and hexagons (C, D) constructed from connector elements according to FIG. 1 and suitable elongate members.

### DETAILED DESCRIPTION OF THE INVENTION

The following description refers to specific embodiments of the present invention and is in no way intended to limit the scope of the present invention to those specific embodiments.

The present invention provides construction kits that may find particular application in an educational setting. Such kits may also be used as a toy. While there are many other “educational” construction kits currently branded as Lego®, Meccano® and FischerTechnik®, most of these kits contain specially designed components and/or a specific selection of components, which are intended to be used primarily for the construction of a particular model or structure. In an educational setting, such directed construction is undesirable as it does not allow for the individual creativity of the student, the adaptability to suit different academic levels, or the ability of a teacher to design suitable construction projects. Accordingly, the present invention provides basic components that may be joined in a myriad number of ways to allow a student the maximum amount of freedom in construction.

The present invention is therefore directed to a primarily educational construction kit that supports and embodies the basic concepts of STEM education policies. The construction kit of the present invention is a geometry-based kit that can be adapted to cater for the needs of different educational levels and one which promotes problem solving, creativity, innovation and object manipulation.

Accordingly, a construction kit of the present invention comprises: at least one connector element/s 100; and at least one elongate member/s 200; wherein each connector element 100 has a substantially regular prismatic shape and wherein each face of each connector element has a substantially centrally-located opening 110 located thereon to receive an end of an elongate member 200 therein or therethrough.

The construction kit may comprise connector elements 100 of different regular shapes. In particular, the connector elements 100 may be selected from the group consisting of: triangular prisms, cuboids, pentagonal prisms, hexagonal prisms, and octagonal prisms.

Being prisms, each connector element 100 will have two end faces 120 and at least three side faces 130. As noted above, each face of each connector element 100 includes a substantially centrally-located opening 110 thereon. The opening 100 on each face is adapted to receive an end of an elongate member 200. In certain embodiments of the present invention, the opening 110 may allow the elongate member 200 to pass through the connector element 100 and out through an opening 110 located on an opposite face (not illustrated). Such an arrangement is particularly preferred for the end faces 120, whereby the elongate member 200 may pass through the length of the connector element 100 thereby allowing for rotation of the connector element 100 about the elongate member 200. In preferred embodiments, the opening 110 on each side face 130 is further adapted to frictionally and releasably retain the end of the elongate member 200 therein, as illustrated in FIG. 2. In particular, in such situations, the opening 110 includes an internal wall 112 that defines a slightly smaller opening than the opening 110 in the side face 130. Upon insertion of the end of the elongate member 200 into the opening 110, the internal wall 112 is adapted to effectively grip the elongate member 200 to thereby retain the elongate member 200 therein, whereby the elongate member 200 is substantially retained in the opening 110 affording stability to the connection between the connector 100 and the elongate member 200.

In certain embodiments of the present invention, additional connector elements 100 can be included in the kit. These additional connector elements 100 may be in the form of regular polyhedrons such as, but not limited to: a tetrahedron, an octahedron, a dodecahedron and an icosahedron. Since such connectors 100 do not have end faces in the same manner as those of a prism, it is envisaged that the opening 110 on each side face is further adapted to frictionally and releasably retain the end of the elongate member 200 therein, as described above.

Construction kits according to the present invention may include one or more types of connector element, as described above. Each type of connector element may represent a set of connector elements. In order to augment the educational value of the kit, different numerical values may be assigned to the different sets of connector element. Further, in order to readily identify each different set of connector element, each set may be assigned an identifying colour.

The connector elements 100 may be made of a single piece or composed of more than one piece, wherein the pieces are joined together. Illustrated are embodiments of both arrangements. In FIG. 3, the two halves 150 are joined by the use of metal pins 152 that are received in recesses 154 that are formed in each half piece 150 (as shown in cross-section) and held in place by frictional engagement. The two halves 150 can be joined by any method suitable for the material from which the connector element 100 is made. In a typical embodiment, the connector element 100 is made of plastic and pieces thereof may be joined using pins 152, as illustrated, or through gluing or plastic welding.

The opening 110 on each face of the connector element 100 is adapted to receive an end of an elongate member 200. Typically, the elongate members 200 are of a substantially constant cross-section selected from the group consisting of: circular, semi-circular, triangular, hexagonal, pentagonal or octagonal. Accordingly, the openings 110 may be substantially circular, semi-circular, triangular, hexagonal, pentagonal or octagonal, depending on the cross-section of the elongate members 200. The elongate members 200 may be substantially hollow for all, or at least a fraction, of their length, or they may be of solid construction.

In order to allow maximum freedom in construction, each elongate member 200 is preferably circular in cross-section along its length. Furthermore, as noted above, an elongate member 200 may be passed through two opposite end faces 120 of a connector element 100 and thereby allow the connector element 100 to rotate about the elongate member 200. Such movement may allow for the construction of dynamic structures.

To allow for the construction of various shapes and objects, the kit may include elongate members 200 of differing lengths. The different lengths preferably differ by integer, fraction, or surd factors from each other. Each length of elongate member 200 may be a member of a set of elongate members. In order to augment the educational value of the kit, different numerical values may be assigned to the different lengths of elongate member 200. Further, in order to readily identify each different length of elongate member 200, each set may be assigned an identifying colour. Connectors and elongate members may have variable values, with the value dependent on the educational level of a user. For example, at lower grade levels where integer addition is a focus, a member and connector may have assigned integer value, such as 2 for a colour (e.g., yellow). In contrast, that same member and connector at a higher grade where fractions is a focus may be assigned a fractional value, such as 5/14 for that same colour (e.g., yellow).

In yet further embodiments of the present invention, the elongate members 200 may be flexible, wherein curves or bends may be introduced into a structure produced using the construction kit. Typically, however, the elongate members 200 are substantially rigid.

Additional components may also be added to the kits of the present invention. These additional components may include, but are not limited to, motors, robotics, wheels and/or panels. The use of such components may allow models or structures made using the kits of the present invention to become dynamic, in that they can move and/or perform functions.

It is further envisaged that adapter components may be incorporated into kits of the present invention. Such adapter components are, in effect, cross-platform pieces that allow elements from other construction sets to be joined to components of kits of the present invention. For example, a given adapter component may allow Lego®-branded blocks to be incorporated into models or structures built using the construction kit of the present invention.

The construction kit of the present invention may be available as a kit comprising various components, such as various sets of connector element and different lengths of elongate member. Alternatively, the kit may comprise a single set of connector element and/or a single length of elongate member.

In use, the construction kit of the present invention has many possible applications. This description will focus solely on the educational uses, but the scope of uses extends beyond this field. The construction kit is most suited to the study of geometry and can cater for all grade levels. The kit may assist with problem solving, creativity and innovation and thereby broaden the education of the student by allowing him/her to interact with a construction kit in a hands-on fashion that requires imagination to develop along with the ability to think in two- and three-dimensions.

In another aspect of the present invention, the construction kit is accompanied by a set of instructions, which provide examples for the teacher to use in an educational setting. It is envisaged that the more frequently teachers use the kit together with the instructions provided in the kit, the more they will increase in confidence. With increased usage, it is also envisaged that teachers will be able to develop their own grade-appropriate problems and outcomes.

While applications of the kit of the present invention relevant to technological and engineering problems in combination with mathematical problems are initially those most readily apparent, the present invention also provides additional opportunities to extend the construction project into solving Science and environmental problems.

In a simple example, such as illustrated in FIG. 4, a teacher assigns a value of 5 to a hexagonal prism connector element and a value of 3 to an elongate member of a given length. The student is instructed to construct a triangle having a total value of 24 (FIG. 4A) and 57 (FIG. 4B), respectively, and a hexagon having a total value of 48 (FIG. 4C) and 71 (FIG. 4D), respectively. It is then for the student to attempt to assemble the shapes, having the appropriate total values. This is a directed exercise with limited outcomes and suited to an introductory grade level. More complexity may be introduced by having different lengths of elongate members, for example, or the instructions may be to construct either an equilateral or an isosceles triangle, having a total assigned numerical value.

In a further example, an open-ended task incorporating an engineering problem in combination with a mathematical problem could be set, whereby the student is required to build a large three-dimensional object, such as a bridge that will support a certain weight. Such a structure may be limited to a total value of 1000, depending on the values assigned to the various components and elongate members to be employed in the task.

The present invention is not to be limited in scope by the specific embodiments and Figures described herein, which are intended as single illustrations of individual aspects of the invention, and functionally equivalent methods and components are within the scope of the invention. Indeed, various modifications of the invention, in addition to those shown and described herein will become apparent to those skilled in the art from the foregoing description and accompanying Figures. Such modifications are intended to fall within the scope of the present invention.

Where the terms “comprise”, comprises”, “comprising”, “include”, “includes”, “included” or “including” are used in this specification, they are to be interpreted as specifying the presence of the stated features, integers, steps or components referred to, but not to preclude the presence or addition of one or more other feature, integer, step, component or group thereof.

Further, any prior art reference or statement provided in the specification is not to be taken as an admission that such art constitutes, or is to be understood as constituting, part of the common general knowledge.

One of ordinary skill in the art will appreciate that materials and methods, other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by examples, preferred embodiments and optional features, modification and variation of the concepts herein disclosed may be resorted to by those skilled in the art, and that such modifications and variations are considered to be within the scope of this invention as defined by the appended claims.

1. A construction kit comprising:
at least one connector element; and
at least one elongate member;
wherein each connector element has a substantially regular prismatic shape and wherein each face of each connector element has a substantially centrally-located opening located thereon to receive an end of an elongate member therein or therethrough.

2. The construction kit of claim 1, wherein the at least one elongate member has a first defined length and is part of a first set of elongate members having the same defined length.

3. The construction kit of claim 2, wherein a second or more elongate member differs in length from the at least one elongate member or each other elongate member by a factor of an integer, a fraction or a surd.

4. The construction kit of claim 3, wherein the second elongate member is part of a second set of elongate members having a second defined length.

5. The construction kit of claim 2, wherein each set of elongate members is of a different colour to each other set of elongate members.

6. The construction kit of claim 5, wherein each connector and each rod are assigned variable values.

7. The construction kit of claim 6, wherein the assigned variable values are selected based on an educational level of a user of the construction kit.

8. The construction kit of claim 1, wherein:
the elongate members are of a substantially constant cross-section selected from the group consisting of: circular, semi-circular, triangular, hexagonal, pentagonal or octagonal; and
wherein the end of each opening on the connector element is complimentarily shaped to the elongate member.

9. The construction kit of claim 1, wherein the at least one connector element having a defined prismatic shape:
is assigned a pre-defined numerical value; and
is part of a set of connector elements.

10. The construction kit according to claim 9, wherein each set of connector elements is of a different colour to each other set of connector elements.

11. The construction kit of claim 1, wherein the prismatic shape of each one or more connector element is the same or different and is selected from the group consisting of: cuboids, pentagonal prisms, hexagonal prisms, and octagonal prisms.

12. The construction kit of claim 11, wherein the prismatic shape of the connector element is substantially cuboid comprising four side faces and two end faces.

13. The construction kit of claim 11, wherein the prismatic shape of the connector element is substantially regular hexagonal comprising six side faces and two end faces.

14. The construction kit of claim 11, wherein the prismatic shape of the connector element is substantially octagonal and comprises eight side faces and two end faces.

15. The construction kit of claim 1, wherein at least one opening is further adapted to substantially frictionally and releasably retain the end of the elongate member therein or therethrough.

16. The construction kit of claim 1, wherein each elongate member is substantially rod-like in construction and has a substantially constant cross-section throughout its length.

17. Use of the construction kit of claim 1, wherein the kit further includes a set of instructions, wherein each instruction is directed to the construction of a structure, wherein the numerical value of the structure does not exceed a pre-defined numerical value contained in the instruction.

18. The construction kit of claim 1, wherein the at least one connector element is made of a single piece.
